(19) United States
(12) Patent Application Publication
(10) Pub. No.: US 2003/0019192 A1
(43) Pub. Date: Jan. 30, 2003

(54) Snaffle bit

(76) Inventors: Jean Kaufmann, Rekingen (CH); Ryan Leith, Rekingen (CH)

Correspondence Address: Friedrich Kueffner, 342 Madison Avenue Suite 1921, New York, NY, 10173, US

(21) Appl. No.: 10/070,648

(22) PCT Filed: Jul. 6, 2001
(86) PCT No.: PCT/CH01/00424

(30) Foreign Application Priority Data
Jul. 10, 2000 (CH) 1355/00

(51) Int. Cl. B68B 1/06

(52) U.S. Cl. 54/8

(57) ABSTRACT

The invention relates to a snaffle bit (1) with a mouthpiece that is inserted in the mouth of a horse or a mule across the tongue. Said snaffle bit is provided with end portions that laterally project from the mouth and that comprise respective through-openings (7) for a pivoted ring (3), and has a downwardly extending bow shape.

The invention pertains to a snaffle bit for horses or mules, consisting of a mouthpiece, which can inserted between the upper and lower jaws to extend crosswise to the mouth, which mouthpiece has a through-opening at each of the two sides projecting from the mouth, a ring for the attachment of a rein or a tether, etc., passing through each of these through-openings.

The snaffle bit forms an important part of the bridle attached to the head of a horse or mule as described and illustrated in, for example, EP-A-0 353 726. It is used to guide the horse or mule securely during riding, during the carrying or pulling of loads, and especially when working in a team.

It is still normal practice to work with unfitted snaffle bits or mouthpieces, which can cause severe pain to the horse or mule, which can lead to abnormal changes in the jaws and dentition, and which all too often alter the character of the animal.

It is therefore important for the snaffle to be designed in such a way that it does put undue stress on the affected parts of the horse or mule and so that it works only to perform its original purpose for the horse or mule.

The task of the invention is to create a snaffle bit of the type indicated above which provides an optimum fit in the lower and upper jaws either under load or without and which treats the other affected parts of the mouth of the horse or mule gently.

This task is accomplished according to the invention in that the mouthpiece is formed by a bow-shaped piece, which curves or angles outward. This does not, however, mean that the mouthpiece must have a form which curves regularly and uniformly over its entire length; on the contrary, it can, for example, have a flatter curvature or a straight section in the area of the tongue, i.e., in the center area. This has the result of reducing the danger of injury to the mouth area of the horse by a snaffle bit, especially when such a bit is used improperly, and it also transmits more effective guidance to the horse.

Of course, the position of the plane in which the bow shape is located can change as a result of the movements of the head of the horse or mule, but the snaffle bit continues to treat the mouth parts gently even when it is in a different position.

It is advantageous for the bow shape of the mouthpiece to be located on a plane which is approximately perpendicular to the through-openings, as a result of which the mouthpiece becomes easy to produce by casting or forging.

When the mouthpiece is designed to consist of several pieces, even lower jaws of different widths can be given a bit with an optimum fit.

A multi-part mouthpiece preferably consists of two downward-curving or downward-angled side parts, which are connected by a joint which can pivot around an axis approximately perpendicular to the plane of the bow.

It is advisable, because of the symmetry of the head parts, for the joint to be located approximately at the center of mouthpiece, so that the force exerted by the reins or tethers will be evenly distributed.

To avoid shear areas and pinching points, a pin passes through the joint-forming ends of the side parts; this pin is held in place in the end of the side part which is designed as a joint fork. As a result, the mouthpiece can be given an almost completely regular cross-sectional form in the area of the joint.

It is advantageous for the mouthpiece to have an upright elliptical cross section in the area of the joint. This shape has been found to be especially favorable for forming the joint and allows a smooth transition between the circular cross section of the mouthpiece and the two ends.

The mouthpiece is advisably made of a nonoxidizing metal such as stainless steel.

To reinforce the free end areas of the mouthpiece with the through-openings, pivot bearing sockets, which form the through-openings, are provided for the pivoting acceptance of the rings provided for a rein or a tether, these sockets being at a right angle or at an angle of less than 90° to the plane of the bow of the mouthpiece and projecting away from the mouthpiece on at least one side, preferably at an angle between 45° and 90°.

The invention is explained below on the basis of an exemplary embodiment with reference to the drawing, to which reference will be made with respect to all of the details not mentioned in the specification:

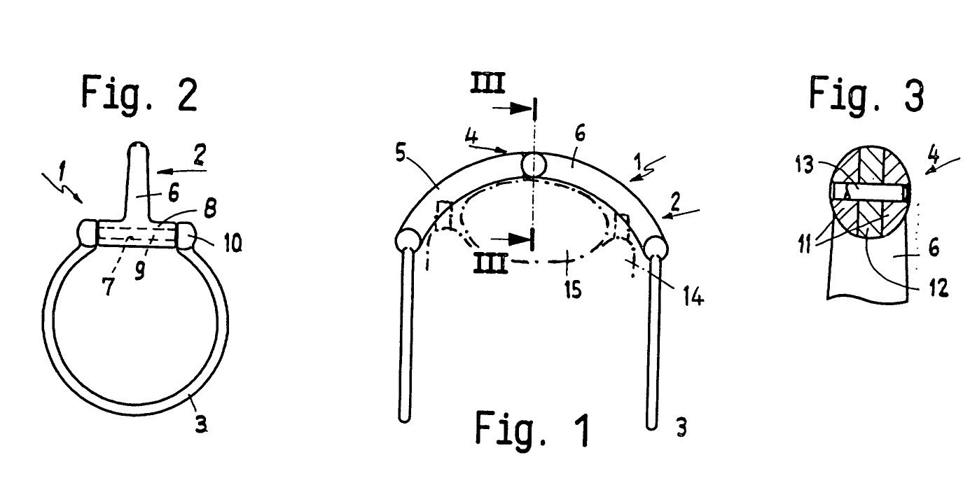

FIG. 1 shows a view of a snaffle bit;

FIG. 2 shows a side view of the snaffle bit according to FIG. 1; and

FIG. 3 shows a cross section through the mouthpiece of the snaffle bit along line III-III of FIG. 1.

FIGS. 1 and 2 show a snaffle bit 1 for a horse or a mule, which consists of a mouthpiece 2, to the free ends of which rings 3 are attached with freedom to pivot for the attachment of a rein or a tether. The mouthpiece 2, when in use, passes through the mouth of the horse or mule, indicated in broken line in FIG. 1, between the upper and the lower jaw 14 and across the tongue 15. It projects out on both sides from the head of the horse or mule, so that the rings 3 for the reins or tethers hang more or less freely downward.

When in use, the mouthpiece 2 has an (outwardly) angled or curved bow shape, lying on a plane. It is divided in the center by a joint 4 into two side parts 5, 6, so that the mouthpiece 2 can be fitted to the mouth and head parts of the horse or mule. This adaptability, as can be seen in FIG. 1, also provides greater comfort for the movements of the jaws and head of the horse or mule and protects the teeth from excessive wear or other damage.

As a result of the curved bow shape, an accidental lateral impact of the snaffle bit against a building or other object is rendered less painful, because the snaffle bit can pivot out of the way in the upward direction.

FIG. 1 also shows the position of the mouthpiece 2 extending across the mouth and its course over the tongue 15 and lower jaw 14, on which the snaffle bit can rest alternately.

The two-part design of the mouthpiece 2 improves its elasticity without causing any loss of effectiveness.

The design of the mouthpiece 2 allows a cross section of less than 12 mm in the mouth area, so that there is no chafing of the affected mouth parts, and a high degree of flexibility is obtained, which helps to safeguard the well-being of the animal.

Approximately perpendicular to the plane of the bow shape of the mouthpiece 2, which can also have an irregular or elliptical shape or the shape of an arc of a circle, a through-opening 7 for a pivoting support element for a ring 3 is provided at each of the free ends of the mouthpiece 2. A shaft 9 passes axially through each of these through-openings 7, which are extended by pivot bearing sockets 8 projecting from both sides of the ends of the mouthpiece 2; these shafts reinforce the ends of the mouthpiece and connect the two end knobs 10 of the interrupted ring 3.

At the same time, the pivot bearing sockets 8 form a lever, which allows the horse or mule to be guided with sensitivity and without the exertion of a great deal of force.

The mouthpiece 2, formed out of two side parts 5, 6, is preferably made of a nonoxidizing metal and is designed in the area of the joint 4 with an upright, elliptical cross section, which changes to an approximately circular cross section as it proceeds toward the free end of the mouthpiece 2. The shafts 9 passing axially through the pivot bearing sockets 8 are anchored at both ends in the knobs 10, which form the ends of the interrupted ring 3. These knobs 10 have approximately the same outside diameter as the pivot bearing sockets 8.

FIG. 3 shows the joint 4 on a larger scale. It shows an elliptical cross section of the joint 4, which consists of a joint fork 11, formed on one of the two side parts 5, 6, and a connecting element 12 between them.

A pin 13, which passes through the connecting element 12, is welded to the outside surfaces of the joint fork 11 on both sides. So that a load-bearing connection between the joint fork 11 and the pin 13 is obtained and so that the external shape of the joint fork 4 is not impaired by the welding or joining of the parts mentioned, the through-openings 7 countersunk from the outside and/or the end of the pin 13 is beveled all the way around the circumference, which is makes it easier to produce a strong weld.

To avoid pinching and shearing points, as illustrated in FIG. 1, the amount of play between the rounded end of the joint fork and the adjacent shoulders of the connecting element 12 is limited to the minimum necessary for the pivoting movement.

1. Snaffle bit (1) for horses or mules, consisting of a mouthpiece (2), which can be placed between the upper and lower jaws and extends crosswise through the mouth, which mouthpiece has a through-opening (7) at each of its two ends projecting out from the sides of the mouth, each opening carrying a ring (3) for the attachment of a rein or a line, etc., characterized in that the mouthpiece (2) is designed with the shape of an outward-curved or outward-angled bow.

2. Snaffle bit according to claim 1, characterized in that the bow shape extends across the tongue (15) and lower jaw (14).

3. Snaffle bit according to claim 1 or claim 2, characterized in that the bow shape of the mouthpiece (2) is located on a plane extending approximately perpendicular to the through-openings (7).

4. Snaffle bit according to one of claims 1-3, characterized in that the mouthpiece (2) consists of several parts.

5. Snaffle bit according to claim 4, characterized in that the mouthpiece (2) consists of two side parts (5, 6), which are connected by a joint (4), which can pivot around an axis approximately perpendicular to the plane.

6. Snaffle bit according to one of claims 3-5, characterized in that the joint (4) is located approximately in the center of the mouthpiece (2).

7. Snaffle bit according to claim 5 or claim 6, characterized in that a pin (13) passes through the ends of the side parts (5, 6) which form the joint (4), the pin being held in place in the end of the one of the two side parts (5, 6) which forms the joint fork (11).

8. Snaffle bit according to one of claims 1-7, characterized in that the cross section of the mouthpiece (2) is approximately circular and/or elliptical.

9. Snaffle bit according to one of claims 1-8, characterized in that the mouthpiece (2) is made of a nonoxidizing material such as steel.

10. Snaffle bit according to one of claims 1-9, characterized in that pivot bearing sockets (8), which project out from at least one side of the through-openings (7) and which represent extensions of these openings, are provided on the free ends of the mouthpiece (2), perpendicular to or at an angle of <90° to the plane formed by the bow shape.
